(19) United States
(12) Patent Application Publication
(10) Pub. No.: US 2008/0221010 A1
(43) Pub. Date: Sep. 11, 2008

(54) Fabric Conditioning Compositions

(76) Inventors: Hannah Faye Earp, Wirral (GB); Mansur Suitan Mohammadi, Wirral (GB); Christopher John Roberts, Wirral (GB)

Correspondence Address: UNILEVER PATENT GROUP, 800 SYLVAN AVENUE, AG West S. Wing, ENGLEWOOD CLIFFS, NJ, 07632-3100, US

(21) Appl. No.: 11/795,443

(22) PCT Filed: Dec. 13, 2005
(86) PCT No.: PCT/EP05/13539

§ 371 Date: Jul. 17, 2007

(30) Foreign Application Priority Data
Jan. 18, 2005 (GB) 0501006.1

(51) Int. Cl. C11D 3/30

(52) U.S. Cl. 510/527

(57) ABSTRACT

An aqueous fabric softening composition comprising: (i) at least one cationic fabric softening compound and (ii) at least one oily sugar derivative which comprises at least 5% by weight of impurities selected from free fatty acid, fatty acid methyl ester, soap, inorganic salts and mixtures thereof. The composition comprising less than 0.5% by weight of fatty complexing agent. The compositions allow impure OSD's to be successfully employed.

### FIELD OF THE INVENTION

The present invention relates to fabric conditioning compositions. More specifically, the invention relates to stable fabric-softening compositions comprising a quaternary ammonium compound and an oily sugar derivative which contain impurities.

### BACKGROUND OF THE INVENTION

It is well known to provide liquid fabric conditioning compositions, which soften in the rinse cycle.

Such compositions comprise less than 7.5% by weight of softening active, in which case the compositions is defined as “dilute”, from 7.5% to about 30% by weight of active in which case the compositions are defined as “concentrated” or more than about 30% by weight of active, in which case the compositions is defined as “super-concentrated”.

Concentrated and super-concentrated compositions are desirable since these require less packaging and are therefore environmentally more compatible than dilute or semi-dilute compositions.

A problem frequently associated with concentrated and superconcentrated compositions, as defined above, is that the product is not stable upon storage, especially when stored in high temperatures. Instability can manifest itself as a thickening of the product upon storage, even to the point that the product is no longer pourable.

The problem of thickening upon storage is particularly apparent in concentrated and superconcentrated fabric softening compositions comprising an ester-linked quaternary ammonium fabric softening material having one or more fully saturated alkyl chains.

However, it is desirable to use ester-linked compounds due to their inherent biodegradability and to use substantially fully saturated quaternary ammonium fabric softening compounds due to their excellent softening capabilities and because they are more stable to oxidative degradation (which can lead to malodour generation) than partially saturated or fully unsaturated quaternary ammonium softening compounds.

Of types of ester-linked quaternary ammonium materials known, it is desirable to use those based on triethanolamine which contain at least some mono-ester linked component and at least some tri-ester linked component since the raw material has a low melting temperature which enables the manufacturing process of the composition to occur at low temperatures. This reduces difficulties associated with high temperature handling, transport and processing of the raw material and compositions produced therefrom.

Frequently, it is desirable to add further ingredients into fabric conditioning compositions in order to provide additional benefits.

One such additional ingredient is an emulsified silicone. Emulsified silicones are desirable because they can provide fabric-conditioning compositions with ease of ironing and anti-crease benefits.

However, it has been found that a conditioning composition comprising a quaternary ammonium material based on triethanolamine, especially when the quaternary ammonium material contains saturated hydrocarbyl groups, can suffer from instability upon storage especially at high temperature when an emulsified silicone is present therein.

WO 03/022969 discloses a fabric conditioning composition comprising:
(a) from about 7.5 to 80% by weight of an ester-linked quaternary ammonium fabric softening material comprising comprising at least one mono-ester linked component and at least one tri-ester linked component;
(b) 0.9% to 15% by weight of a fatty complexing agent;
(c) an emulsified silicone
   wherein the weight ratio of the mono-ester linked component of compound (a) to compound (c) is from 5:1 to 1:5 and the emulsifier for the silicone comprises a non-ionic emulsifier.

The compositions exhibit improved storage at high temperature. The compositions may comprise an oily sugar derivative as a co-active softener and as a replacement for silicone oils.

Oily sugar derivatives have been suggested for use in fabric conditioning compositions.

WO 98/16538 discloses a fabric softening composition comprising:
i) a liquid or soft solid derivative of a cyclic polyol (CPE) or of a reduced saccharide (RSE) resulting from 35 to 100% of the hydroxyl groups in the cyclic polyol or reduced saccharide being esterified or etherified, the derivate (CPE or RSE) having at least 2 or more of ester or ether groups independently attached to a C₈-C₂₂ alkyl or alkenyl chain or mixtures thereof, and containing at least 35% tri or higher esters;
ii) a disposition aid.

WO 00/70004 discloses a fabric softening composition comprising:
(i) a liquid or soft solid derivative of a cyclic polyol (CPE) or of a reduced saccharide (RSE) resulting from 35 to 100% of the hydroxyl groups in the polyol or saccharide being esterified or etherified, the CPE or RSE having 2 or more ester or ether groups independently attached to a C₈-C₂₂ alkyl or alkenyl chain, wherein at least one of the chains attached to the ester or ether groups has at least one unsaturated bond, and
(ii) a deposition aid, and
(iii) one or more antioxidant(s),
   wherein the weight ratio of i) to iii) is 20:1 or greater.

WO 01/46359 discloses a fabric softening composition comprising:
(i) at least one oily sugar derivative which is a liquid or soft solid derivative of a cyclic polyol or of a reduced saccharide, said derivative resulting from 35 to 100% of the hydroxyl groups in said polyol or in said saccharide being esterified or etherified, and wherein, the derivative has two or more ester or ether group independently attached to alkyl or alkenyl chains derived from a fatty acid mixture of tallow fatty acid and oleyl fatty acid, and
(ii) one or more deposition aids.

WO 01/46360 discloses a method of improving the viscosity stability upon storage of a fabric softening composition comprising:
(a) 0.5% to 30% by weight of at least one ester-linked quaternary ammonium fabric softening compound,
(b) perfume, and
(c) an alkoxylated non-ionic surfactant by the inclusion in the composition of at least one oily sugar derivative in a weight ratio of softening compound to sugar derivative in the range of 30:1 to 1:1.

WO 01/46361 discloses a fabric softening composition comprising;
(i) one or more cationic fabric softening compound(s) having two or more alkyl or alkenyl chains each having an average chain length equal to, or greater than C₈ and
(ii) at least one oily sugar derivative which is a liquid or soft solid derivative of a cyclic polyol or of a reduced saccharide, said derivative resulting from 35 to 100% of the hydroxyl groups in said polyol or in said saccharide being esterified or etherified, and wherein, the derivative has two or more ester or ether groups independently attached to a C₈-C₂₂ alkyl or alkenyl chain, and
(iii) a deposition aid comprising a mixture of one or more nonionic surfactant(s), said one or more one cationic polymer(s).

WO01/46363 discloses a method for the preparation of an aqueous fabric softening composition comprising:
(i) at least one cationic fabric softening compound having two or more alkyl or alkenyl chains each having an average chain length equal to, or greater than C₈, and
(ii) at least one oily sugar derivative,
   wherein the cationic fabric softening compound (i), and/or the oily sugar derivative (ii) is/are separately mixed with another active component of the fabric softening composition to form a pre-mixture prior to the admixing of the softening compound (i) with the oily sugar derivative (ii).

WO01/46513 discloses the use of a fabric treatment composition to provide anti creasing properties and/or ease or ironing benefits to a fabric wherein said composition-comprises:
(i) an oily sugar derivative which is a liquid or soft solid derivative of a cyclic polyol or of a reduced saccharide, said derivative resulting from 35 to 100% of the hydroxyl groups in said polyol or in said saccharide being esterified or etherified, and wherein said derivative has two or more ester or ether groups independently attached to a C₈-C₂₂ alkyl or alkenyl chain, and
(ii) one or more deposition aid(s).

WO03/022967 discloses a method of thinning a fabric conditioning composition comprising (a) from 7.5 to 80% by weight of an ester-linked quaternary ammonium fabric softening material comprising at least one mono-ester linked component and at least one tri-ester linked component comprising the step of adding a fatty complexing agent (b) to the composition in an amount such that the weight ratio of the mono-ester linked component of compound (a) to fatty complexing agent (b) is from 2.93:1 to 1:5.

The compositions may additionally comprise an oily sugar derivative.

oily sugar derivatives (OSD's) are desirable as fabric conditioners on their own right and as adjuncts in the commercial cationic softeners. They are environmentally benign and sustainable raw materials from a non-oleochemical source. They are excellent natural non-ionic softeners synthesised from sugar and oils of vegetable or animal source. OSD's are desirable in traditional cationic softeners as co-active to provide a range of tactile and olfactory benefits. The prior arts compositions utilise pure OSD's. Pure OSD's also have been shown to improve the inherent poor high temperature storage stability of cationic softeners as disclosed in WO 01/46360.

However pure OSD's are expensive and commercially not viable for use in fabric softeners. It has been found that cheap commercial OSD's can severely shorten the stability period of cationic softener formulations when stored at high ambient temperatures.

OSD's are synthesised using sucrose and natural oils derivatives. The esterification process is driven by catalysts and reaction conditions that can leave reaction impurities in the final OSD products. Some of these impurities are undesirable for inclusion in cationic fabric conditioners and induce severe viscosity instability when the product is stored at ambient temperatures shortening the shelf life of such products. The purification process adds on to the cost of these products making them too expensive for incorporation into commodity fabric conditioners.

It is an object of the present invention to provide fabric conditioner compositions which allow the use of impure OSD products but which overcome the instabilities which occur with the use of impure OSD's.

### SUMMARY OF THE INVENTION

According to the present invention there is provided an aqueous fabric softening composition comprising:
(i) at least one cationic fabric softening compound
(ii) at least one oily sugar derivatives which comprises at least 5% by weight of impurities selected from free fatty acid, soap, fatty acid methyl ester, and inorganic salts and mixtures thereof,
   the composition comprising less than 0.5% by weight of fatty complexing agent.

The compositions of the invention allow the use of impure OSD's to form stable formulations while retaining the benefits associated with pure OSD's

### Oily-Sugar Derivatives (OSD's)

OSD's are the reaction products of fatty acid methyl ester (FAME) of natural oils and sucrose. The reaction impurities and the level of impurities left in the final product depend on the synthesis process. Two pathways from the prior art include
a non-solvent route as described in EP323670B1 and EP383404B1 both to Unilever and
a solvent route as described in WO200146210, WO98/16538 and WO01/46359A1 (Unilever).

In the solvent-free synthesis route the fatty acid methyl ester (FAME) is trans-esterified with the polyol (sugar) with the aid of a catalyst such as alkali metal hydroxides or carbonates. An often essential component in the initial heterogeneous reaction mixture is an emulsifier or a dispersing agent such as alkali metal soaps. EP323670B1 discusses the problems of purifying the resulting OSD's from the soap residue.

Other residues, in addition to soap, include metal salts resulting from the catalyst, unreacted FAME and fatty acids if the soap residue is neutralised with acids.

In the solvent route the resulting OSD's are relatively pure and contain only traces of solvent. However the solvent route of OSD production may be undesirable on the environmental and cost grounds.

This invention is concerned with the influence of possible impurities on the storage stability of fabric conditioners into which such impure OSD's have been incorporated. The invention is particularly concerned with formulating impure OSD's derived from natural oils predominantly comprising C₁₆ and C₁₈ hydrocarbon chains e.g. palm kernel oil. The impure OSD's are generally present in an amount of from 0.5 to 10%, preferably 1 to 5% by weight of the composition.

### Fatty Complexing Agent

The prior art fabric softening compositions containing an OSD generally comprise a fatty complexing agent to maintain viscosity stability. Examples of fatty complexing agents include fatty alcohols and fatty acids and of these fatty alcohols were most preferred.

It has been found that the presence of the OSD impurities, particularly the soap and acid residues, in combination with a fatty complexing agent, lead to instability of the fabric softening composition and in particular to an unacceptable increase in viscosity when stored at elevated temperature.

Without being bound by theory it is believed that this thickening problem is caused by the presence of soap/acid residues in the OSD production. Soaps can flocculate the cationic softener droplets and by incorporation into the cationic droplets can also increase their volume leaving less space for particle manoeuvre in the product which is tantamount to a thicker less pourable product. By reducing the level of fatty complexing agent the phase volume occupied by the cationic droplets is reduced enabling a prolonged stability period. Therefore in accordance with the invention the fabric softening compositions contain less than 0.5% by weight of the fatty complexing agent, preferably less than 0.2% by weight and most preferably are free of fatty complexing agent.

### Fabric Softening Compound

The fabric softening compounds used in the invention are cationic in nature. Preferably the cationic fabric softening compound of the invention is a quaternary ammonium material. Preferably the quaternary ammonium material has two long chain alkyl or alkenyl chains with an average chain length greater than C₁₄, more preferably each chain has an average chain length greater than C₁₆, more preferably at least 50% of each long chain alkyl or alkenyl group has a chain length of C₁₈.

It is preferred if the long chain alkyl or alkenyl groups of the fabric softening compound are predominantly linear.

The cationic fabric softening compositions used in the invention are compounds which provide excellent softening, characterised by a chain melting Lβ to Lα transition temperature greater than 25° C., preferably greater than 35° C., most preferably greater than 45° C. This Lβ to Lα transition can be measured by differential scanning calorimetry (DSC) as defined in the “Handbook of Lipid Bilayers, D Marsh, CRC Press, Boca Raton Fla., 1990 (pages 137 and 337).

It is especially preferred if the fabric softening compound is a quaternary ammonium material which comprises a compound having two C₁₂₋₁₈ alkyl or alkenyl groups connected to the molecule via at least one ester link. It is more preferred if the quaternary ammonium material has two ester links present. Preferred ester-linked quaternary ammonium materials for use in the invention can be represented by the formulae:

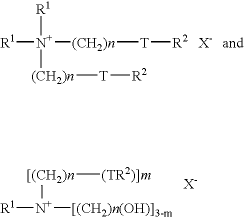

wherein each R¹ group is independently selected from C₁₋₄ alkyl, hydroxyalkyl or C₂₋₄ alkenyl groups; and wherein each R² group is independently selected from C₈₋₂₈ alkyl or alkenyl groups;

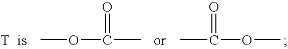

X⁻ is any suitable anion including halide, acetate and lower alkylsulphate ions e.g. chloride, methyl sulphate, ethyl sulphate,
n is 0 or an integer from 1-5 and
m is 1, 2 or 3 and denotes the number of moieties to which it refers that pend directly from the N atom. For TEA quat the average number of chains m can be a non-integer.

Especially preferred materials within this formula are di-alkenyl esters of triethanol ammonium methyl sulphate and N-N-di (tallowoyloxy ethyl) N,N-dimethylammonium chloride. Commercial examples of compounds within this formula include Tetranyl AHT-1 (di-hardened tallow ester of triethanol ammonium methyl sulphate 85% active), AO-1 (di-oleic ester of triethanol ammonium methyl sulphate 90% active), Ll/90 (palm ester of triethanol ammonium methyl sulphate 90% active (supplied by Kao corporation) and Rewoquat WE18 (C₁₆-C₁₈ unsaturated fatty acid reaction products with triethanolamine dimethyl sulphate quaternised 90% active), ex Witco Corporation.

A second preferred type of quaternary ammonium material can be represented by formula:

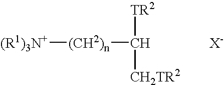

wherein R¹, R², X⁻, n and T are as defined above.

Preferred materials of this class such as 1,2 bis[hardened tallowoyloxy]-3-trimethylammonium propane chloride and their method of preparation are, for example, described in U.S. Pat. No. 4,137,180 (Lever Brothers). Preferably these materials comprise small amounts of the corresponding monoester as described in U.S. Pat. No. 4,137,180 for example 1-hardened tallowoyloxy-2-hydroxy trimethylammonium propane chloride.

It is advantageous for environmental reasons if the quaternary ammonium material is biologically degradable.

The fabric softening agent may also be polyol ester quats (PEQs) as described in EP 0638 639 (Akzo).

The present invention is found to be particularly effective for liposomal dispersions of the above mentioned fabric softening components. It is also particularly effective for dispersions containing unsaturated softener systems.

If the quaternary ammonium compound comprises hydrocarbyl chains formed from fatty acids or fatty acyl compounds which are unsaturated or at least partially unsaturated (e.g. where the parent fatty acid or fatty acyl compound from which the quaternary ammonium compound is formed has an iodine value of from 5 to 140, preferably 5 to 100, more preferably 5 to 60, e.g. 5 to 40) then the cis:trans isomer weight ratio in the fatty acid or fatty acyl compound is greater than 20:80, preferably greater than 30:70, more preferably greater than 40:60, e.g. 70:30 or more. It is believed that higher ratios of cis to trans isomer afford the compositions comprising the quaternary ammonium compound better low temperature stability and minimal odour formation.

Saturated and unsaturated fatty acids or acyl compounds may be mixed together in varying amounts to provide a compound having the desired iodine value.

Alternatively, fatty acids or acyl compounds may be hydrogenated to achieve lower iodine values.

Of course the cis:trans isomer weight ratios can be controlled during hydrogenation by methods known in the art such as by optimal mixing, using specific catalysts and providing high H₂ availability.

The fabric softening compounds are generally present in an amount of from 5 to 30% by weight of the compositions, preferably 7 to 25% by weight of the composition.

### Composition pH

The compositions of the invention preferably have a pH of at least 1.5 and/or less than 5, more preferably at least 2.5 and/or less than 4.

### Additional Stabilising Agents

The compositions of the present invention generally contain additional stabilising agents.

Compositions of the invention preferably contain nonionic stabilisers. Suitable nonionic stabilisers which can be used include the condensation products of C₈-C₂₂ primary linear alcohols with 10 to 25 moles of ethylene oxide. Use of less than 10 moles of ethylene oxide, especially when the alkyl chain is in the tallow range, can lead to unacceptable aquatic toxicity. Particularly preferred nonionic stabilisers include Genapol T-110, Genapol T-150, Genapol T-200, Genapol C-200, Genapol C-100, Genapol C-150 all ex Hoechst, Lutensol AT18 ex BASF. Preferably the nonionic stabiliser has an HLB value of from 10 to 20, more preferably 12 to 20. Preferably, the level of nonionic stabiliser is within the range of from 0.05 to 10% by weight, more preferably from 0.1 to 5% by weight, most preferably from 0.4 to 4% by weight, based on the total weight of the composition.

### Additional Viscosity Control Agent

Any viscosity control agent used with rinse conditioners is suitable for use with the present invention, for example biological polymers such as Xanthan gum (Kelco ex Kelsan and Rhodopol ex Rhodia), Guar gum (Jaguar ex Rhodia), starches, modified starches and hydrophobically modified cellulose ethers. Synthetic polymers are useful viscosity control agents such as polyacrylic acid, poly vinyl pyrolidone, polyethylene, carbomers, cross linked polyacrylamides such as Acosol 880/882 polyethylene and polyethylene glycols.

### Other Ingredients

The composition can also contain one or more optional ingredients, selected from solvents, pH buffering agents, perfumes, perfume carriers, colorants, hydrotropes, antifoaming agents, polymeric or other thickening agents, opacifiers, and anti-corrosion agents.

### Liquid Carrier

The liquid carrier employed in the instant compositions is preferably water due to its low cost relative availability, safety, and environmental compatibility. The level of water in the liquid carrier is more than about 50%, preferably more than about 80%, more preferably more than about 85%, by weight of the carrier. The level of liquid carrier is greater than about 50%, preferably greater than about 65%, more preferably greater than about 70%. Mixtures of water and a low molecular weight, e.g. <100, organic solvent, e.g. a lower alcohol such as ethanol, propanol, isopropanol or butanol are useful as the carrier liquid. Low molecular weight alcohols including monohydric, dihydric (glycol, etc.) trihydric (glycerol, etc.), and a polyhydric (polyols alcohols are also suitable carriers for use in the compositions of the present invention.

### Processing

The incorporation of the OSD into the fabric softening composition may conveniently be by first making an emulsion of the OSD in-situ using a co-melt of OSD and nonionic emulsifier and then adding the cationic softener/nonionic/±fatty complexing agent co-melt. Alternatively a pre-made emulsion of the OSD may be post-dosed into the remainder of the composition.

The invention will be illustrated by the following Examples in which compositions of the invention are represented by a number and comparative compositions represented by a letter.

### EXAMPLES

In order to confirm the effect of the impurities of OSD's on fabric softening compositions pure palm kernel OSD (OSD-PKO) was prepared by solvent route as disclosed in WO98/16538 and WO01/46359A1 where palm kernel fatty acid (Cognis) was used to create the acid chloride by:

1. dissolving the sucrose in pyridine at 120° C. and cooling (this stays in solution)
2. Adding acid chloride (there is virtually no residual acid Cl or sucrose)
3. Any residual pyridine was removed by an acid wash dissolved in water and acid wash in HCl, repeated a few times, (under vacuum and then rotary evaporate).

The pure OSD-PKO was used in the formulation reported in Table 1.

TABLE 1
Examples prepared at 3.5 kg scale

| Raw Material | A | B | C | D | E | F |
|---|---|---|---|---|---|---|
| Tetranyl AHT-1 | 10.5 | 10.5 | 10.5 | 10.5 | 10.5 | 10.5 |
| Genapol C200 | 0.6 | 0.6 | 0.6 | 0.6 | 0.6 | 0.6 |
| Hydrenol D | 0.83 | 0.83 | 0.83 | 0.83 | 0.83 | 0.83 |
| Pure OSD PKO | 4.22 | 4.01 | 3.8 | 4.01 | 4.21 | 3.8 |
| Genapol C200 | 0.28 | 0.28 | 0.28 | 0.28 | 0.28 | 0.28 |
| K oleate (40% paste ex. | | 0.21 | 0.42 | | 0.084 | |
| Sigma Aldrich) | | | | | | |
| Na oleate (100% powder | | | | 0.21 | | |
| ex. Sigma Aldrich) | | | | | | |
| Fatty acid methyl ester | | | | | | 0.42 |
| (Edenor PK 12-18K) | | | | | | |
| Process | a | a | a | a | a | a |

Tetranyl AHT-1 is a fully hardened tallow TEA quat supplied by KAO at 85% active level (contains 15% IPA); Genapol C200 is a coco (C9-C11)20EO nonionic (Clariant), Hydrenol D (Cognis) is a fully hardened vegetable derived C₁₆-C₁₈ fatty alcohol.

### Process (a)

Start temperature=60° C.
Add OSD and NI co-melt under agitation
Mill for 1 batch volume
Add TEAQ/NI/±fatty alcohol co-melt under agitation
Mill for 0.5 batch volumes

### Cool to 50° C.

Mill for 2 batch volumes while continuing cooling
Add perfume at 45° C.
Turn mill off and continue cooling to 30° C.

### Discharge at 30° C.

The Examples in Table 1 represent levels of impurity from 2 to 10% in ODS—‘A’ represents a pure OSD, ‘B’, ‘C’ and ‘E’ represent 5, and 2% potassium oleate soap levels respectively, ‘D’ a 5% sodium oleate soap and ‘F’ a 10% FAME level.

The stability of the formulations at 37° C. is reported in Table 2.

TABLE 2
Storage at 37° C. viscosity mPa s @ 106 S⁻¹

| Weeks | A | B | C | D | E | F |
|---|---|---|---|---|---|---|
| 0 | 35 | 23 | 52 | 21 | 40 | 41 |
| 1 | 35 | 29 | 160 | 22 | 44 | 30 |
| 2 | 37 | 34 | solid | 26 | 35 | 48 |
| 4 | 38 | 100 | | 52 | 47 | 46 |
| 8 | 25 | solid | | solid | 45 | 40 |

The results demonstrate that composition A using a pure OSD is stable. When impurities in the form of sodium or potassium oleate are added in amounts of about 5% by weight based on the OSD, compositions B, C, D become unstable. Fatty acid methyl ester (composition F) does not seem to contribute to instability. About 2% soap is tolerated as composition N shows.

The following examples in Table 3 compare the impact of the formulation ingredients on the stability of an impure sample of OSD-PKO obtained by the non-solvent route as detailed in EP323670B1.

TABLE 3

| Formulation | G | H | I | 1 | 2 |
|---|---|---|---|---|---|
| Tetranyl AHT-1 | 11.4 | 10.5 | 10.5 | 10.5 | 11.00 |
| Genapol C200 | 0.3 | 0.6 | 0.6 | 0.6 | 0.75 |
| Hydrenol D | 1.6 | 0.83 | 0.83 | x | x |
| OSD-PKO | x | 4.22 | 4.22 | 4.22 | 3.75 |
| Genapol C200 | x | 0.28 | 0.28 | 0.28 | 0.25 |
| Silicone emulsion | 5 | x | x | x | x |
| PROCESS | c | b | a | b | b |
| SCALE (Kg) | 3.5 | 3.5 | 3.5 | 3.5 | 3.5 |

Silicone emulsion is a high MW PDMS silicone oil (ex DC) emulsified with nonionic ethoxylate surfactants as described in WO03022969(A1).

The fabric softener formulations reported in Table 3 in which the ingredients are expressed in weight % were prepared.

### Process (b)

Start temperature=60° C.
Add OSD and NI co-melt under agitation
Mill for 1 batch volume
Add TEAQ/nonionic/±fatty alcohol co-melt under agitation
Mill and cool for 1.5-2 batch volumes
Add perfume at 50° C.
Turn mill off and continue cooling to 30° C.

### Discharge at 30° C.

### Process (c)

An alternative way of incorporating OSD's in a fabric conditioner is by post-dosing a pre-made emulsion of the OSD into the finished fabric conditioner. Composition A uses this route where a pre-formed silicone emulsion is post-dosed.

The storage stability of the compositions is reported in Table 4.

TABLE 4

| | | Viscosity mPa s @ 106 s⁻¹ | | | |
|---|---|---|---|---|---|
| | Days on | Storage Temperature | | | |
| Composition | Store | 5° C. | 20° C. | 33° C. | 37° C. |
| G | 0 | 94 | 94 | 94 | 94 |
| | 7 | 73 | 81 | 92 | 98 |
| | 14 | 76 | 88 | 92 | 120 |
| | 28 | 77 | 89 | 102 | 244 |
| | 56 | 223 | 86 | 99 | solid |
| H | 0 | 66 | 66 | 66 | 66 |
| | 7 | 75 | 60 | 92 | 130 |
| | 14 | 66 | 78 | 105 | 150 |
| | 28 | 66 | 80 | 125 | 260 |
| | 56 | 69 | 89 | 118 | solid |
| | 84 | 70 | 89 | 244 | solid |
| I | 0 | 38 | 38 | 38 | 38 |
| | 14 | 32 | 39 | 73 | 332 |
| | 42 | 36 | 45 | 114 | solid |
| | 56 | 35 | 46 | 114 | solid |
| | 84 | 40 | 50 | 307 | solid |
| 1 | 0 | 87 | 87 | 87 | 87 |
| | 7 | | 105 | 106 | 113 |
| | 14 | | | 109 | 115 |
| | 21 | 101 | 85 | 108 | 113 |
| | 28 | | 92 | 106 | 136 |
| | 42 | 114 | | 105 | 161 |
| | 49 | 111 | 102 | 116 | 152 |
| | 56 | 115 | | 93 | 203 |
| 2 | 0 | 64 | 64 | 64 | 64 |
| | 28 | 53 | 53 | 69 | 85 |

The high temperature storage behaviour of composition H and I is comparable to the behaviour of compositions B, C and D in which the impurities have deliberately been added to the pure OSD-PKO. When the level of fatty complexing agent is reduced as in composition 1 the high temperature stability is greatly increased and the system becomes tolerant to the impurities.

The level of nonionic stabilising agent plays an important role in the length of storage stability. Increased levels can reduce the initial viscosity and extend the stability period as composition 2 demonstrates. The extended visco-stability is not purely a result of the lower initial viscosity but of inherently more stable system against soap flocculation (the rate of viscosity increase is smaller for larger nonionic levels).

The formulations reported in Table 5 were prepared by post dosing a pre-made emulsion of the OSD-PKO of Table 3 into the fabric conditioner after cooling to 30° C. without exposing the final product to milling or shear when the OSD-PKO was present.

TABLE 5

| Formulation | J | K |
|---|---|---|
| Tetranyl AHT-1 | 11.4 | 11.47 |
| Genapol C200 | 0.3 | 0.33 |
| Hydrenol D | 1.6 | 0.9 |
| OSD-PKO as a 40% emulsion | 5 | 5 |
| Perfume | 0.95 | 0.95 |
| Scale (Kg) | 3.5 | 3.5 |

The storage stability of the composition is reported in Table 6.

TABLE 6

| | | Viscosity mPa s @ 106 s⁻¹ | | | |
|---|---|---|---|---|---|
| | Days on | Storage Temperature. | | | |
| Composition | Storage | 5° C. | 20° C. | 33° C. | 37° C. |
| J | 0 | 145 | 145 | 145 | 145 |
| | 7 | 146 | 161 | 213 | 366 |
| | 14 | 164 | 192 | 133 | solid |
| K | 0 | 38 | 38 | 38 | 38 |
| | 7 | 45 | 42 | 48 | 140 |
| | 14 | 31 | 44 | 59 | 215 |

The stability results in Table 6 further show it is the level of fatty alcohol complexing agent that determines the length of stability.

Although the starting viscosity of high fatty complexing composition (J) is larger than (K) and it may be expected that this will reach a high viscosity sooner the results show that the rate of increase in viscosity (rather than the absolute values) is larger for composition J. High levels of fatty complexing agent as stated earlier gives rise to a higher phase volume and hence a larger viscosity to begin with.

1. An aqueous fabric softening composition comprising:
(i) at least one cationic fabric softening compound and
(ii) at least one oily sugar derivative which comprises at least 5% by weight of impurities selected from free fatty acid, fatty acid methyl ester, soap, inorganic salts and mixtures thereof.
the composition comprising less than 0.5% by weight of fatty complexing agent.

2. An aqueous fabric softening composition as claimed in claim 1 which is free of fatty complexing agent.

3. An aqueous fabric softening composition as claimed in claim 1 in which the cationic fabric softening compound is represented by the formula: 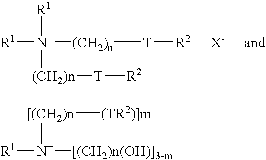
wherein each R¹ group is independently selected from C₁₋₄ alkyl, hydroxyalkyl or C₂₋₄ alkenyl groups; and wherein each R² group is independently selected from C₈₋₂₈ alkyl or alkenyl groups; 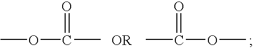
X⁻ is any suitable anion including halide, acetate and lower alkylsulphate ions e.g. chloride methyl sulphate, ethyl sulphate,
n is 0 or an integer from 1-5 and
m is 1, 2 or 3 and denotes the number of moieties to which it refers that pend directly from the N atom.

4. A fabric softening composition according to claim 1 in which the fabric softening compound is a quaternary ammonium material which comprises a compound having two C₁₂₋₁₈ alkyl or alkyl groups connected to the molecule via at least one ester link.

5. A fabric softening composition as claimed in claim 1 comprising quaternary ammonium fabric softening material comprising at least one mono-ester linked component and at least one tri-ester linked component.

6. A fabric softening composition as claimed in claim 1 which additionally comprises from 0.2 to 5% by weight of a nonionic surfactant.

7. A fabric softening composition as claimed in claim 6 which comprises from 0.4 to 4% by weight of a nonionic surfactant.

8. A fabric softening composition as claimed in claim 6 in which the nonionic surfactant is an ethoxylated nonionic surfactant having from 10 to 25 moles of ethylene oxide.

9. A fabric softening composition as claimed in claim 1 in which the oily sugar derivative is the reaction product of sucrose with a natural oil predominantly comprising C₁₆ and C₁₈ hydrocarbon chains, obtained by a solvent-free synthesis route.

10. A fabric softening composition as claimed in claim 9 in which the natural oil is palm kernel oil.

11. A fabric softening composition as claimed in claim 1 in which the cationic fabric softening compound is present in an amount of from 5 to 30% by weight of the composition.

12. A fabric softening composition as claimed in claim 1 in which the cationic fabric softening compound is present in an amount of from 7 to 25% by weight of the composition.

13. A fabric softening composition as claimed in claim 1 in which the oily sugar derivative is present in an amount of from 0.5 to 10% by weight of the composition.

14. A fabric softening composition as claimed in claim 13 in which the oily sugar derivative is present in an amount of from 1 to 5% by weight of the composition.
